(19) United States
(12) Patent Application Publication
(10) Pub. No.: US 2011/0035949 A1
(43) Pub. Date: Feb. 17, 2011

(54) Scissors with specific cut length

(76) Inventor: Jon P. Fesler, Barry, IL (US)

Correspondence Address: THE BREVETTO LAW GROUP, PLLC, P.O. Box 808, QUINCY, IL, 62306-0808, US

(21) Appl. No.: 12/830,297

(22) Filed: Jul. 3, 2010

Related U.S. Application Data
(60) Provisional application No. 61/274,386, filed on Aug. 17, 2009.

(51) Int. Cl. B26B 13/00

(52) U.S. Cl. 30/233

(57) ABSTRACT

Scissors including a stop on one of the blades located a specified distance from one end of the blade. The stop allows the user of the scissors to easily make repeated cuts of the same specified length by inserting a material into the opening between the blades until it hits the stop. Upon closing the blades a cut of the specified length is created. The stop may be implemented as a notch in the blade of the scissors, or as a separate part attached with pins to the blade allowing the user to position the moveable stop over different sets of pins to provide different distances from the end of the blade to the stop, so that the user can select the length of the desired cut.

### CROSS-REFERENCE TO RELATED APPLICATIONS

This application claims the benefit of and priority to U.S. Provisional Application 61/274,386 filed on Aug. 17, 2009, titled “¼ Inch cut quilting scissors”, applied for by Jon P. Fesler, which is incorporated herein by reference in its entirety.

### BACKGROUND

1. Technical Field

The present subject matter relates to hand tools for cutting, specifically to scissors constructed to create a cut of a predetermined length.

2. Description of Related Art

Scissors have been used for many years and for many purposes. One use for scissors is in the quilting and sewing arts where two pieces of fabric are often joined together by stitching the two pieces of fabric together with a seam. The seam is usually near an edge of both pieces of fabric, and with a skilled seamstress or seamster, the seam is at a specific fixed distance from the edge. The portion of the fabric between the seam and edge of the fabric is known as the seam allowance.

Typically, seams are sewn on the inside or reverse side of a particular piecework, project or garment to hide the seam allowance. When the item is inverted, or turned right side out, the seam sometimes may have unsightly bulges or buckles visible from the front due to the seam allowance's inability to shift and lay flat, especially along curved seams. To minimize this problem, slits are often cut at intervals into the seam allowance, from the edge of the fabric right up to the seam, before the two pieces of fabric are opened up, or the item is turned right side out, to expose the finished side of the item. These slits alleviate the problem of bulges or buckles by giving freedom of movement to the seam allowance and allowing the seam to lay flat and straight, even on curved seams such as armholes or necklines. These slits are often cut even on straight seams, such as those commonly used for quilting, as bunching and buckling can occur as the finished item is moved and bent if the slits are not present.

Cutting slits can be slow and painstaking work, as it is important to cut right up to the seam but even more important not to cut the seam itself. Conventional scissors have no way of limiting the length of the cut, so the quilter must be very careful not to cut too far, yet to cut far enough to allow the freedom of movement of the seam allowance to provide the necessary flexibility when the item is eventually inverted or turned right side out. In the past, several attempts have been made to create scissors with a way of measuring or limiting the scissors' cut.

U.S. Pat. No. 6,647,842, issued on Dec. 17, 2002 and published U.S. Patent Application No. 2008/0034594, published on Feb. 14, 2008, describe a scissors with an integrated measuring tool. While scissors built with such a measuring mechanism may allow the user to know how deep they are cutting, they do nothing to keep the user from cutting deeper than intended.

U.S. Pat. No. 3,898,734, issued on Aug. 12, 1975, describes shears with cutting blade tips offset from the line of cut to stop the shears from cutting out to the tips of the blades. While this does limit the cutting action of the shears, the cut length will still vary depending on how widely the blades of the shears are opened.

U.S. Pat. No. 5,499,454, issued on Mar. 19, 1996, involves adjustable scissors for cutting buttonholes. Scissors built in this manner have blades with cutting surfaces of limited length and a notch between the cutting surfaces and the pivot point. The device also has an adjustment means to limit the extent to which the scissors' blades can be closed, thereby limiting the length of the cut of the scissors. While useful for buttonholes, scissors built in this manner do not address the need to cut a specified distance from the edge of a piece of fabric such as needed to cut slits into a seam allowance.

So the need exists for scissors that allow the user to easily and repeatedly cut a specific length from the edge of a piece of fabric or other material.

### SUMMARY

The scissors disclosed are comprised of a two blades. Each blade has a handle at one end, a cutting edge extending from the other end, an external edge, an outer surface, and a flat inner surface that extends between the cutting edge and external edge. The two blades are pivotally connected about a pivot point so that moving the handles apart creates an opening between the two cutting edges. Subsequently moving the handles back together causes the two flat inner surfaces to slide over each other, bringing the cutting edges into close cutting engagement, creating a shearing action capable of cutting a material that has been inserted into the opening.

The scissors disclosed also include a stop on one of the blades located a distance from the end that has the cutting edge. The stop is configured so that its inner surface does not extend beyond the inner surface of the blade so as not to interfere with the cutting action of the cutting edges. The stop also has a blocking edge extending beyond the cutting edge in a direction away from the external edge so as to be substantially perpendicular to the cutting edge. The distance from the end of the blade to the blocking edge may vary between embodiments but for embodiments targeting sewing or quilting uses the distance will usually be between one tenth of an inch and one inch. One common use of cutting slits in the seam allowance of sewing projects calls for an embodiment with that distance set to about one quarter of an inch.

In some embodiments, the stop may be implemented as a notch in the blade of the scissors. One side of the notch would have the cutting edge and the other side of the notch would act as the stop. The side of the notch with the cutting edge would extend from the end of the blade back to the stop in a radial direction toward the pivot point of the scissors. The side of the notch acting as the stop would be substantially perpendicular to the first side.

In some embodiments incorporating a notch for a stop, the edge of the blade from the stop back toward the handle may not be sharp to avoid any accidental cutting. In other embodiments, the edge of the blade from the stop back toward the handle may include another cutting edge to allow the scissors to be used normally as well as in the mode of creating a cut with a specific length.

While many embodiments of the present subject matter are likely to use a fixed stop, creating a scissors that is designed to always make the same length cut, other embodiments may want to allow the user to determine the desired cut length for a given set of cuts. To enable this, some embodiments may create a scissors with a moveable stop. In one embodiment, the stop is held in place on the blade using magnetic attraction. In another embodiment, small pins extend out from the blade's outer surface and the moveable stop has holes, so that the stop can be positioned against the blade in such a way that the pins extend into the holes of the moveable stop. In one embodiment, the pins are in a straight line at a regular interval and the moveable stop has a pair of holes that match the interval of the pins. In this way, the moveable stop can be positioned in one of several different locations for different purposes.

The manner in which the various embodiments are used is similar. The scissors would be opened by separating the handles, creating an opening between the two cutting edges. The material to be cut would then be inserted into the opening until it hits the blocking edge of the stop. Then when the handles are pushed back together, the material will be cut to the specified length determined by the distance between the end of the scissors and the blocking edge of the stop.

### BRIEF DESCRIPTION OF THE DRAWINGS

The accompanying drawings, which are incorporated in and constitute part of the specification, illustrate various embodiments of the invention. Together with the general description, the drawings serve to explain the principles of the invention. In the drawings:

FIG. 1A shows a “right-handed” embodiment of the scissors with specific cut length;

FIG. 1B shows a “left-handed” embodiment of the scissors with specific cut length;

FIG. 2A shows scissors with a notch acting as the stop;

FIGS. 2B, 2C and 2D show the scissors of 2A in three different states of openness;

FIG. 3 shows the scissors cutting slits in the edge allowance of a sewing project;

FIGS. 4A and 4B show a scissors with pins to position a moveable stop and the moveable stop; and

FIGS. 5A and 5B show the scissors with the moveable stop in two different positions.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details, in other instances, well known methods, procedures and components have been described at a relatively high-level, without detail, in order to avoid unnecessarily obscuring aspects of the present concepts. A number of descriptive terms and phrases are used in describing the various embodiments of this disclosure. These descriptive terms and phrases are used to convey a generally agreed upon meaning to those skilled in the art unless a different definition is given in this specification. For example, the term seam allowance is generally known to be the area or distance between the edge and the stitching line on two (or more) pieces of material being stitched together. Reference now is made in detail to the examples illustrated in the accompanying drawings and discussed below.

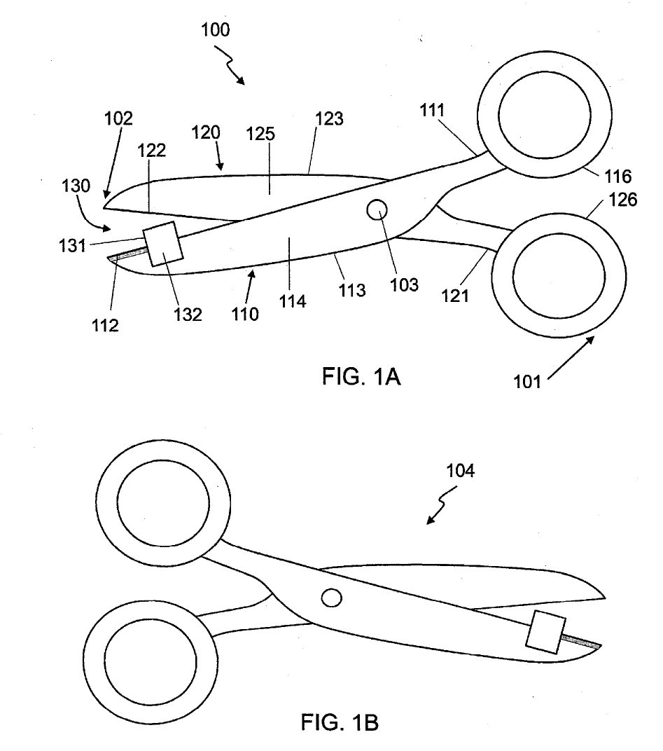

FIG. 1A shows an example embodiment of the scissors 100 with specific cut length. The scissors 100 can be of any size, depending on the embodiment. Typical embodiments targeting sewing and quilting applications may be from six to ten inches in length but some embodiments may be longer or shorter than that range. The scissors and its components can be made from any material suitable for scissors or components of scissors including but not limited to steel, plastic, glass, magnets and carbon fiber.

The scissors 100 have a proximal end 101 and a distal end 102. The scissors 100 are comprised of a first blade 110 and a second blade 120. The first blade 110 and the second blade 120 each have a blade tip at their respective distal ends. The first blade 110 has a handle 111 including a finger hole 116 at the proximal end 101 and a cutting edge 112 at the distal end 102. The first blade 110 also has an external edge 113, an outer surface 114 and an inner flat surface that extends from the cutting edge 112 to the external edge 113. The inner flat surface is on the back of the first blade 110 in the orientation shown in FIG. 1 and is therefore not visible.

The second blade 120 has a handle 121 including a finger hole 126 at the proximal end 101 and a cutting edge 122 at the distal end 102. The second blade 120 also has an external edge 123, an outer surface that is not visible in FIG. 1A because it is on the back of the second blade 120 in the orientation shown, and an inner flat surface 125 that extends from the cutting edge 122 to the external edge 123.

The cutting edges 112 and 122 may be straight or curved and are typically sharpened on only the side extending toward the outer surface (114 on the first blade and not shown on the second blade). The angle of the sharpening and therefore, the degree of sharpness of the cutting edges 112 and 122 depends on the embodiment's targeted use. In the case of children's scissors, the cutting edges 112 and 122 may have no sharpening at all and may even have a slight bevel on side of the inner flat surface (not shown on the first blade and 125 on the second blade). For scissors intended to be used for fabric, the angle of the sharpening might be fairly acute giving very sharp cutting edges 112 and 122.

The finger holes 116 and 126 are shown as round elements in scissors 100. Other embodiments with different shapes for the finger holes such as where the finger holes may be asymmetric with one finger hole round and the other oblong or where the finger holes are offset from one another or designed with an ergonomic shape are also possible. In yet other embodiments, the finger holes may be eliminated and other ways of manipulating the handles such as paddles, levers or other connections to the handles, may be provided.

The two blades 110 and 120 are pivotally connected at a pivot point 103 allowing the two blades 110 and 120 to swing about the pivot point 103 as a double lever. Moving the handles 111 and 121 apart creates an opening 130 between the cutting edges 112 and 122. Then as the handles are moved back together, the inner surfaces of the blades slide smoothly across each other, causing the two cutting edges 112 and 122 to be in a close cutting engagement with a shearing action to cut any material that has been inserted into the opening 130.

The scissors 100 shown in FIG. 1A are right-handed scissors because if a right hand is used to operate the scissors, with the right thumb in finger hole 116 and one or more right fingers in finger hole 126, the natural closing motion of the human hand, where the thumb extends outward from the palm as it closes, forces the two cutting edges 112 and 122 together giving a better shearing action. In addition, the material being cut is not hidden by the top blade (the second blade 112 in FIG. 1A) if the scissors are held in the right hand. FIG. 1B shows a left-handed scissors 104 embodiment of the present subject matter. For clarity, specific details are not described for the left-handed scissors 104, but all the details disclosed in this specification apply equally to right-handed and left-handed scissors.

Continuing on with the details of FIG. 1A, the first blade 110 includes a stop 132 at a predetermined distance from the distal end 102. The stop 132 of this embodiment can be attached to the blade in many different ways including, but not limited to welding, gluing, riveting, and magnetic attraction or it could be fabricated as an integral part of the first blade 110. In accordance with various embodiments the stop 132 can be attached to either of the blades, and the blade to which the stop 132 is attached can be called either the first stop or the second stop. In some embodiments the stop 132 is configured to be moveable with a method provided for the user to change the distance from the distal end 102 where it is attached. The stop 132 has an inner surface that does not extend past the inner surface of the first blade so as not to impede the shearing action of the cutting edges 112 and 122.

The stop 132 has a blocking edge 131. The blocking edge 131 extends beyond the cutting edge 112 in a direction away from the external edge. It extends far enough to stop the material that the scissors are intended to cut from being inserted between the blades 210 and 220 past the blade tip by more than a predetermined depth, e.g., ¼ inch. In one embodiment, the blocking edge 131 extends about one quarter inch beyond the cutting edge 112. The angle between the blocking edge 131 and the cutting edge 112 should be such that, upon inserting a material into the opening 130, the material will be stopped by blocking edge 131. If the angle is too obtuse, the material may have a tendency to slide up the blocking edge 131 giving inconsistent cut lengths. If the angle is too acute, the thickness of the material will impact the depth that the material may be inserted into the angle giving incorrect cut lengths. While some embodiments may target uses where the material is always of a uniform thickness allowing an acute angle to be used, for most embodiments the angle between the blocking edge 131 and the cutting edge 112 should be substantially perpendicular. Substantially perpendicular, in various embodiments, is typically 90 degrees plus or minus a set amount, with the set amount being, for example, anywhere from 0 to 10 degrees. However, in some embodiments substantially perpendicular can be construed to mean any angle between 60 degrees and 120 degrees. Typically, an edge of the blocking edge 131 face is perpendicular to the center axis through the pivot point 103 which extends through the two blades 110 and 120. That is, a plane extending through an edge of the blocking edge 131 face to the nearest point on the pivot point center axis is perpendicular to a plane extending through the pivot point center axis to the nearest point on the blocking edge 131 line.

With the handles 111 and 121 moved apart an opening 130 is created between the cutting edges 112 and 122, allowing material to be inserted into the opening by the user until it hits the blocking edge 131. Then when the handles 111 and 121 are moved back together, the two cutting edges 112 and 122 cut a slit into the material with the depth of the slit being the same as the predetermined distance from the stop 132 to the distal end 102 of the scissors 100. This allows the user to make repeated slits with a consistent length. Different embodiments have different predetermined distances from the blocking edge 131 to the distal end 102. For example, in various embodiments the predetermined distance may be between one tenth of an inch and one inch. One common predetermined distance of various embodiments is substantially one-quarter of an inch, so that the scissors 100 can be easily used in the quilting and sewing arts for cutting slits in the seam allowance. A distance referred to as substantially one-quarter of an inch can be interpreted as one-quarter of an inch plus/minus 10%.

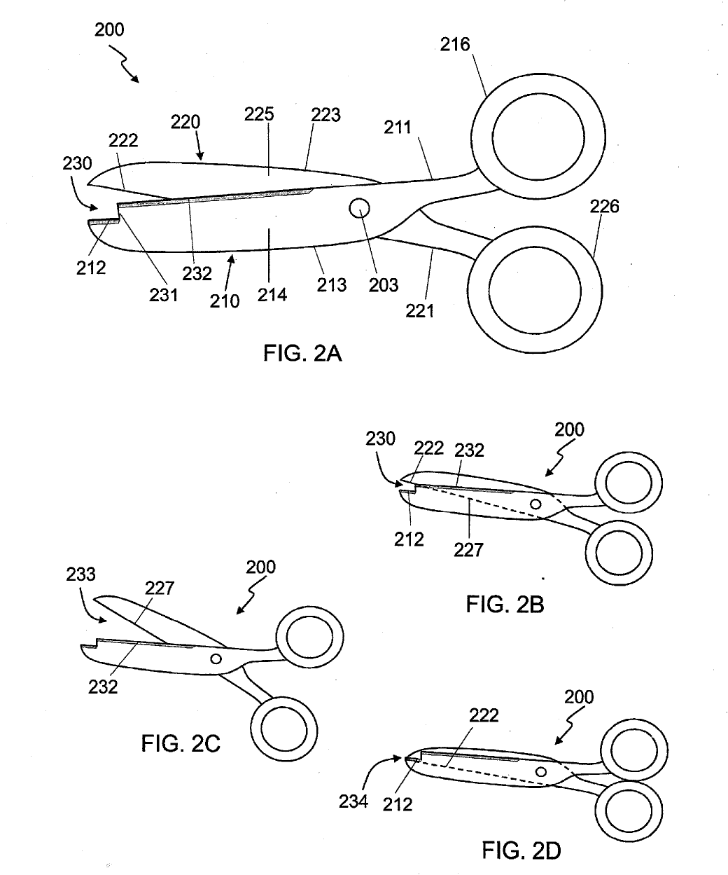

FIG. 2A depicts an embodiment of scissors 200 that uses a notch incorporated directly into the first blade 210 as the stop. The scissors 200 are comprised of a first blade 210 and a second blade 220. The first blade 210 has a handle 211 including a finger hole 216 at the proximal end and a cutting edge 212 at the distal end. The first blade 210 also has an external edge 213, an outer surface 214 and an inner flat surface that extends from the cutting edge 212 to the external edge 213. The inner flat surface is on the back of the first blade 210 in the orientation shown in FIG. 2A and is therefore not visible.

The second blade 220 has a handle 221 including a finger hole 226 at the proximal end and a cutting edge 222 at the distal end. The second blade 220 also has an external edge 223, art outer surface that is not visible in FIG. 2A because it is on the back of the second blade 220 in the orientation shown, and an inner flat surface 225 that extends from the cutting edge 222 to the external edge 223.

The two blades 210 and 220 are pivotally connected at a pivot point 203 allowing the two blades 210 and 220 to swing about the pivot point 203 as a double lever. In various embodiments a number of different pivot point fasteners may be used to connect the two blades 210 and 220, include for example, a rivet, a screw, a bolt, and a pin. Moving the handles 211 and 221 apart creates an opening 230 between the cutting edges 212 and 222. Then as the handles 211 and 221 are moved back together, the inner surfaces of the blades slide smoothly across each other, causing the two cutting edges 212 and 222 to be in a close cutting engagement with a shearing action to cut any material that has been inserted into the opening 230.

Continuing on with the details of FIG. 2A, the first blade 210 includes a notch functioning as a stop. The notch has two sides. The first side of the notch is the cutting edge 212. The second side of the notch is the blocking edge of the stop 231 at a given distance from the distal end of the first blade. In this embodiment, the inner surface of the stop is one and the same as the inner surface of the first blade. The angle between the two sides of the notch should be such that a material inserted into the opening 230 is stopped by blocking edge 231. In this embodiment the angle between the blocking edge 231 and the cutting edge 212 is substantially perpendicular. An additional cutting edge 232 is included on the first blade 210 in this particular embodiment. The additional cutting edge 232 extends from the blocking edge 231 back toward the proximal end.

FIGS. 2B, 2C and 2D show three different states of openness of the scissors 200 to illustrate their use with many of the reference numbers omitted for clarity. The reference numbers shown in FIG. 2A apply to each part in FIG. 28, 2C and 2D. Finger holes 216 and 226 are moved by the user to change the angle of the blades 210 and 220. In FIG. 2B the finger holes 216 and 226 have been opened by a given amount just far enough to create an opening 230 between the cutting edges 212 and 222 and bounded by the blocking edge 231. Opening the first and second handles using finger holes 216 and 226 to separate the first blade tip from the second blade tip by a given amount allows the material being cut to enter between the first blade 210 and the second blade 220 by up to the predetermined depth of the blocking edge, e.g., ¼ inch. Thus, the user can insert material into the opening 230 until it is stopped by the blocking edge 231. Then the user can squeeze the two handles 211 and 221 together to create a cutting action between the cutting edges 212 and 222 to make a cut of a specific length, for example, the predetermined length of ¼ inch. The position of the scissors with the handles 211 and 221 have been squeezed together is shown in FIG. 2D. In FIG. 2D the cutting edge 222 of the second blade 220 has slid completely past the cutting edge 212 of the first blade 210 so that there is no opening 234 left. This allows the entire length from the blocking edge 231 to the distal end of the blades 210 and 220 to cut the material inserted into the opening 230. When used in this way the user is able to make repeated cuts with a consistent length.

The scissors 200 are opened more fully in FIG. 2C by separating the finger holes 216 and 226 farther apart, opening the first and second handles to separate the first blade tip from the second blade tip by more than a given amount allows the material to enter between the first blade 210 and the second blade 220 by more than the predetermined cutting depth past the blocking edge of stop 231. This creates a larger opening 233 between the additional cutting edge 232 on the first blade 210 and the more proximal portion 227 of the cutting edge 222 of the second blade 220. By then squeezing the finger holes 216 and 226 back together until they are in the position shown in FIG. 2B, the more proximal portion 227 of the cutting edge 222 on the second blade 220 slides across the additional cutting edge 232 of the first blade 210 causing a cutting action so that the scissors 200 can be used in a more conventional manner using the additional cutting edge 232 without a limit (e.g., ¼ inch) on cut length.

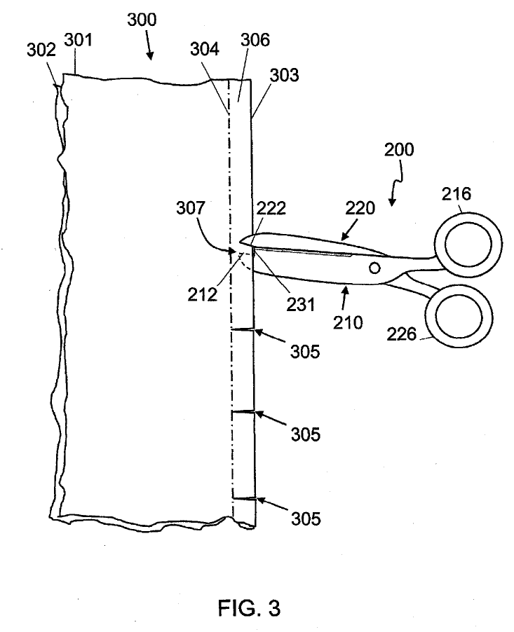

Looking now to FIG. 3, a portion of a sewing project 300 is shown where two pieces of fabric, a top piece 301 and a bottom piece 302, have been lined up with their edges 303 lined up, and sewn together using seam 304. The scissors 200 are being used to cut slits 305 into the seam allowance 306. The finger holes 216 and 226 have been separated far enough to create an opening between the cutting edges 212 and 222 on the two blades 210 and 220. The user (not shown) of the scissors 200 has then placed the sewing project 300 into the opening between the cutting edges 212 and 222 at the location of the next desired slit 307 until the edges 303 of the fabric pieces 301 and 302 have come up against the blocking edge 231. The user has chosen a scissors 200 with the distance from the blocking edge 231 to the distal end of the blades 210 and 220 to match the width of the seam allowance 306. In choosing scissors 200 with the matching distance, it is very easy for the user to cut the proper length slits 305 into the seam allowance 306 without worrying about cutting too deeply and cutting the seam 304 or cutting too shallowly and having the chance of unsightly bulge or buckles in the sewing project 300.

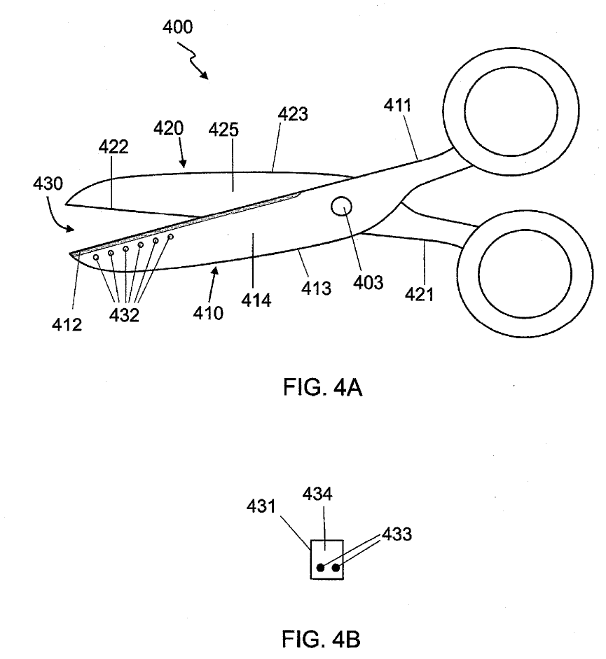

FIGS. 4A and 4B show two different pieces that together form an embodiment of disclosed subject matter with a moveable stop. The scissors 400 are comprised of a first blade 410 and a second blade 420. The first blade 410 has a handle 411 at the proximal end and a cutting edge 412 at the distal end. The first blade 410 also has an external edge 413, an outer surface 414 and an inner flat surface that extends from the cutting edge 412 to the external edge 413. The inner flat surface is on the back of the first blade 410 in the orientation shown in FIG. 4A and is therefore not visible.

The second blade 420 has a handle 421 at the proximal end and a cutting edge 422 at the distal end. The second blade 420 also has an external edge 423, an outer surface that is not visible in FIG. 4A because it is on the back of the second blade 420 in the orientation shown, and an inner flat surface 425 that extends from the cutting edge 422 to the external edge 423.

The two blades 410 and 420 are pivotally connected at a pivot point 403 allowing the two blades 410 and 420 to swing about the pivot point 403 as a double lever. Moving the handles 411 and 421 apart creates an opening 430 between the cutting edges 412 and 422. Then as the handles are moved back together, the inner surfaces of the blades slide smoothly across each other, causing the two cutting edges 412 and 422 to be in a close cutting engagement with a shearing action to cut any material that has been inserted into the opening 430.

A plurality of locater pins 432 are fixed to the first blade 410. While six locater pins are shown in FIG. 4A, any number of locater pins may be used. The locator pins 432 extend from the outer surface 414 of the first blade 410. In one embodiment, the locater pins 432 extend out about 0.5 mm. In this embodiment, the locater pins are in a straight line and located at a regular interval. This regular interval will determine the granularity of the adjustability of the stop. In the one particular embodiment shown in FIG. 4A, 4B, 5A and 5B, the locater pins 432 are located to allow placement of the moveable stop in a distance ranging from one eighth to five eighths of an inch at one eighth inch increments. In other embodiments, other ranges of adjustability might be enabled, such as from one tenth inch to one inch.

A moveable stop 434 is shown in FIG. 4B. In one embodiment, the moveable stop 434 would be about 7 mm wide, 5 mm high and 0.75 mm thick. The moveable stop 434 has a blocking edge 431 and holes 433 that are each large enough to accept a locator pin. The moveable stop 434 can have any number of holes 433 but two are shown in this embodiment. The moveable stop 434 can then be placed by the user at the desired location on the first blade 410 by inserting the proper locater pins 432 into the holes 433 of the moveable stop 434. In some embodiments, the moveable stop 434 and first blade 410 are magnetically attracted to each other to keep the moveable stop 434 in place on the first blade 410.

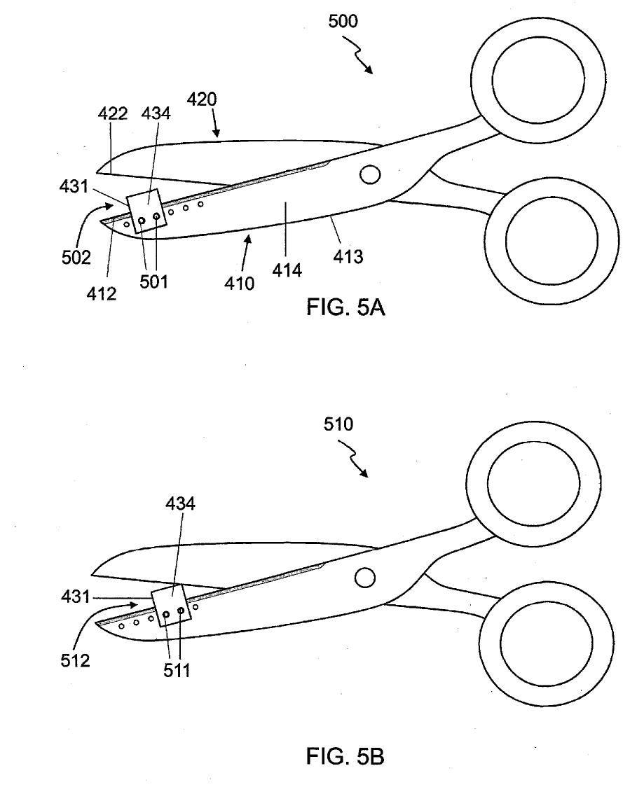

Two different placements of the moveable stop 434 on the first blade 410 are shown in FIGS. 5A and 5B. In FIG. 5A, the scissors with moveable stop 500 has the moveable stop 434 located on the second and third locator pins 501. The moveable stop 434 is placed against the outer surface 414 of the first blade 410 with the second and third locator pins 501 inserted into the holes 433 of the moveable stop 434 to locate the blocking edge 431 of the moveable stop 434 at a specific distance 502 from the distal end of the blades 410 and 420. In this embodiment, placing moveable stop 434 on the second and third locater pins 501 puts the blocking edge 431 one quarter of an inch from the distal end of the blades 410 and 420. The moveable stop extends beyond the cutting edge 412 in a direction away from the external edge 413 to create the blocking edge 431. So when the user inserts material into the opening between the cutting edges 412 and 422 until it hits the blocking edge 431, and closes the scissors 500 of FIG. 5A, a cut of one quarter of an inch will be made.

FIG. 5B shows the moveable stop 434 placed in a different location than in FIG. 5A. Scissors with moveable stop 510 in FIG. 5B has the moveable stop 434 placed over the fourth and fifth locater pins 511 creating a distance 512 of one half inch from the blocking edge 431 to the distal end of the scissors 510 in the particular embodiment. So when the user inserts material into the opening until it hits the blocking edge 431, and closes the scissors 510 of FIG. 5B, a cut of one half of an inch will be made.

Unless otherwise indicated, all numbers expressing quantities of elements, distances, and so forth used in the specification and claims are to be understood as being modified in all instances by the term “about.” Accordingly, unless indicated to the contrary, the numerical parameters set forth in the preceding specification and attached claims are approximations that can vary depending upon the desired properties sought to be obtained by those skilled in the art utilizing the teachings of the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviations found in their respective testing measurements.

The recitation of numerical ranges by endpoints includes all numbers subsumed within that range (e.g. 1 to 5 includes 1, 1.5, 2, 2.75, 3, 3.80, 4, and 5). As used in this specification and the appended claims, the singular forms “a”, “an”, and “the” include plural referents unless the content clearly dictates otherwise. Thus, for example, reference to an element described as “a hole” may refer to a single hole, two holes or any other number of holes. As used in this specification and the appended claims, the term “or” is generally employed in its sense including “and/or” unless the content clearly dictates otherwise.

The description of the various embodiments provided above is illustrative in nature and is not intended to limit the invention, its application, or uses. Thus, variations that do not depart from the gist of the invention are intended to be within the scope of the embodiments of the present invention. Such variations are not to be regarded as a departure from the intended scope of the present invention.

What is claimed is:

1. A scissors configured to make cuts of a predetermined depth on material, the scissors comprising:
a first blade with a first blade tip and a first handle at an end opposite the first blade tip, the first blade further comprising a first cutting edge extending from the first blade tip toward a first blade pivot point;
a second blade with a second blade tip and a second handle at an end opposite the second blade tip, the second blade further comprising a second cutting edge extending from the second blade tip; and
a blocking edge arranged on the second blade a distance of the predetermined depth from the second blade tip, the second cutting edge extending from the second blade tip to the blocking edge;
wherein the blocking edge is configured to prevent the material from entering between the first blade and the second blade past the second blade tip by more than the predetermined depth.

2. The scissors of claim 1, further comprising:
pivot fastener means configured to hold the first blade pivot point adjacent the second blade pivot point so the first cutting edge scrapes against the second cutting edge as the first and second handles are rotated in opposite directions;
wherein opening the first and second handles to separate the first blade tip from the second blade tip by a given amount allows the material to enter between the first blade and the second blade by up to the predetermined depth to the blocking edge.

3. The scissors of claim 2, further comprising:
a third cutting edge on the second blade extending from the blocking edge toward the pivot point;
wherein opening the first and second handles to separate the first blade tip from the second blade tip by more than the given amount allows the material to enter between the first blade and the second blade by more than the predetermined depth to the third cutting edge past the blocking edge.

4. The scissors of claim 3, wherein the second cutting edge is not parallel to the third cutting edge; and
wherein a face of the blocking edge separates the second cutting edge from the third cutting edge, an inner edge of said face being perpendicular to an axis bisecting the pivot fastener means.

5. A scissors comprising:
a first blade having a first handle at a proximal end, a first cutting edge extending from a distal end toward the proximal end, a first external edge, a first outer surface, and a first inner flat surface between the first cutting edge and the first external edge;
a second blade having a second handle at the proximal end, a second cutting edge extending from the distal end toward the proximal end, a second external edge, a second outer surface, and a second inner flat surface between the second cutting edge and the second external edge, the second handle pivotally connected to the first handle about a pivot point; and
a stop on the first blade, the stop having:
a third inner surface that does not extend inward past the first inner flat surface; and
a blocking edge extending beyond the first cutting edge in a direction away from the first external edge;
the stop positioned on the first blade with a specific distance from the distal end of the first blade to the blocking edge of the stop.

6. The scissors of claim 5, wherein the blocking edge is substantially perpendicular to the first cutting edge;
wherein moving the first handle away from the second handle creates an opening between the first cutting edge and the second cutting edge; and
wherein subsequently moving the first handle back toward the second handle causes the first inner flat surface to slide over the second inner flat surface bringing the first cutting edge into close cutting engagement with the second cutting edge.

7. The scissors of claim 5, wherein the specific distance from the distal end of the first blade to the blocking edge of the stop is at least one tenth of an inch and less than one inch.

8. The scissors of claim 5, wherein the specific distance from the distal end of the first blade to the blocking edge of the stop is substantially one quarter of an inch.

9. The scissors of claim 5, further comprising:
a notch in the distal end of the first blade;
the notch having a first side that extends in a radial direction toward the pivot point and a second side that is substantially perpendicular to the first side;
the first cutting edge being on the first side of the notch; and
the second side of the notch being the blocking edge of the stop.

10. The scissors of claim 9 in which the third inner surface is flat and coplanar with the first inner flat surface; and
the first blade further comprises a third cutting edge extending from the blocking edge of the stop toward the proximal end;
wherein sufficiently separating the first handle from the second handle creates an opening between the third cutting edge and the second cutting edge; and
wherein subsequently moving the first handle back toward the second handle causes the third inner flat surface to slide over the second inner flat surface bringing the third cutting edge into close cutting engagement with the second cutting edge.

11. The scissors of claim 10, wherein the specific distance from the distal end of the first blade to the blocking edge of the stop is about one quarter of an inch.

12. The scissors of claim 5, wherein the stop is a moveable stop; and
wherein the moveable stop is magnetically attracted to the first blade.

13. The scissors of claim 12, further comprising:
a plurality of locater pins fixed to the first blade;
the plurality of locater pins extending out from the first outer surface;
the moveable stop having a hole large enough to allow at least one of the plurality of locater pins to fit into the hole;
wherein the moveable stop can be located at a plurality of locations on the first blade depending on which of the at least one of the plurality of locater pins are inserted into the hole of the moveable stop.

14. The scissors of claim 13, wherein the plurality of locater pins are all of equal size and are fixed to the first blade in a straight line substantially parallel to the first cutting edge with a regular interval between centers.

15. The scissors of claim 14, wherein the moveable stop has at least two holes located in a line substantially perpendicular to the blocking edge, each one of the at least two holes large enough to allow one of the plurality of locater pins to fit into the hole, the at least two holes located to have a distance between centers that is the same as the regular interval between centers of the plurality of locater pins.

16. The scissors of claim 15, wherein the plurality of locater pins are located to allow the moveable stop to be positioned at multiple locations so that the distance from the distal end of the first blade to the blocking edge of the moveable stop is at least one tenth of an inch and less than one inch.
